(19) United States
(12) Patent Application Publication
(10) Pub. No.: US 2009/0057303 A1
(43) Pub. Date: Mar. 5, 2009

(54) MODULAR WALL HOUSING UNIT FOR ELECTRICAL COMPONENTS

(75) Inventors: DENNIS ODDSEN, EATONS NECK, NY (US); COSMO CASTALDO, WESTBURY, NY (US)

Correspondence Address: Collard & Roe, P.C./Leviton, 1077 Northern Blvd, Roslyn, NY, 11576, US

(73) Assignee: LEVITON MANUFACTURING COMPANY, INC., LITTLE NECK, NY (US)

(21) Appl. No.: 11/848,903

(22) Filed: Aug. 31, 2007

(51) Int. Cl. H02G 3/08

(52) U.S. Cl. 220/3.5

(57) ABSTRACT

The disclosure relates to an electrical component connection device which includes a first housing in the form of a wall box and a second housing for inserting into the first housing in a telescoping manner. The second housing is for receiving and holding at least one electrical component such as a receptacle or a switch. The housing and the second housing can be coupled together via a plurality of connection elements. The housing can have a first set of connection elements, while the second housing can have a second set of connection elements. These connection elements may include a ratcheted section and a plurality of slotted sections disposed on each side of the ratcheted section. This ratcheted section on the housing can comprise a plurality of teeth each having a sloping front face facing a front edge of the housing and a flat face facing a back edge of the housing. The second set of connection elements may include a plurality of teeth, each having a sloping front face facing a front edge of the second housing and a flat back face facing a back edge of the second housing.

### BACKGROUND OF THE INVENTION

The invention relates to a modular wall housing unit which can be connected to another component such as an additional housing which holds an electrical component such as an electrical receptacle, a switch or an electrical combination device.

Modular units for electrical components are known in the art, for example, U.S. Pat. No. 6,309,248 issued on Oct. 30, 2001, and U.S. Pat. No. 6,767,245 issued on Jul. 24, 2004, both to Gerald King, disclose a modular GFCI receptacle unit, wherein the disclosures of these patents are hereby incorporated herein by reference in their entirety.

Other modular units are shown in U.S. Pat. Nos. 6,863,561 and 6,341,981 both to Gorman, wherein these patents relate to a safety electrical outlet and switch system. This system includes a plurality of connectable modular components for installing electrical components into a wall of a residential or a commercial building.

One of the problems associated with a wiring installation in a building is the positioning of an electrical unit in a wall. In some cases, both the height of the wall mounted electrical unit and the depth of the electrical unit in the wall must be carefully positioned to meet particular building codes. For example, some building codes require that outlets are spaced 18 inches from the floor while switches are spaced 36 inches from the floor. Thus, for a proper installation, the installer must carefully measure beams or studs in a wall and also determine the proper installation point for a wall box.

In addition to the height and depth of the electrical component, it is important that the electrical component be securely fastened into a wall box as well.

The careful positioning of this electrical component in a wall, along with the need for a secure physical and electrical connection can result in a relatively time consuming installation of wall mounted electrical components.

To overcome this relatively time consuming installation, and to ease the complexity of the installation, at least one embodiment of the present invention provides a new modular connection element which is designed to overcome these drawbacks in installation.

### SUMMARY OF THE INVENTION

One embodiment of the invention relates to an electrical component connection device comprising a first housing comprising a wall box, and an second housing for inserting into the wall box in a telescoping or depth adjustable manner. This second housing is adapted to receive at least one electrical component such as, for example, a wall mounted switch, or a wall mounted receptacle unit. To connect the electrical component to the wall box, a connection element or connector is adapted to connect the first housing to the second housing. This connection element has slots which create a more flexible connection element to facilitate insertion and removal of the second housing from the first housing.

Optional features associated with this first housing can include a lip for setting a depth of positioning of the first housing on a beam, or a notch which can be used for determining a proper height for placement of the first housing on a beam.

The wallbox or first housing can have position indicators as well. These position indicators are in the form of a locator element in the form of prongs, pins, or tabs. In at least one embodiment the locator element is in the form of a ferromagnetic element such as a strip of iron or steel.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a front perspective view of a first housing;

FIG. 2 is a top front perspective view of the first housing shown in FIG. 1;

FIG. 3A is a perspective view of the second housing and the first housing;

FIG. 3B is a perspective view of a second embodiment of the second housing;

FIG. 4 is a perspective view of the second housing inserted into the first housing and having a wall board disposed in front;

FIG. 5A is a perspective view of the second housing and a receptacle being inserted into the first housing with a first embodiment of a wiring unit;

FIG. 5B is a perspective view of the design shown in FIG. 5A with another embodiment of a wiring unit;

FIG. 5C is a perspective view of the design shown in FIG. 5A with still another embodiment of a wiring unit;

FIG. 6 is a perspective view of the second housing, the receptacle and the first housing;

FIG. 7 is a perspective view of the device in an assembled condition; and

FIG. 8 is a flow chart for a process for assembling the device.

### DETAILED DESCRIPTION OF PREFERRED EMBODIMENTS

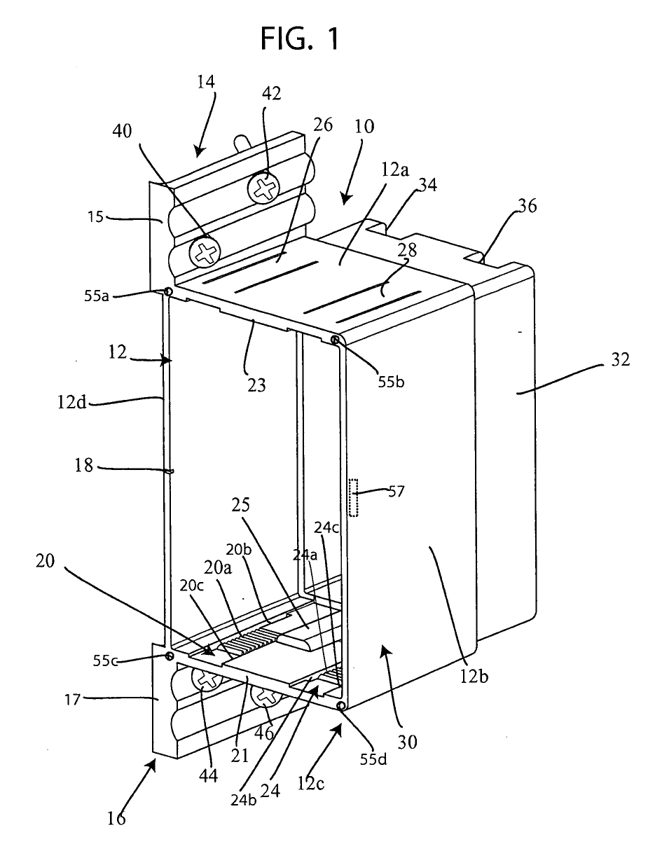

FIG. 1 is a perspective view of a modular wiring box device 10. This modular wiring box includes a wallbox or first housing 12 having four sides 12a, 12b, 12c, and 12d. First housing 12 can have a series of brackets including a first bracket 14 and a second bracket 16. First bracket 14 includes a lip 15 while second bracket 16 includes a lip 17. Lip 15 and lip 17 are used to set first housing 12 in a position along a beam such that a front edge of first housing 12 extends along a plane that is substantially parallel to a plane formed by a front face of a corresponding beam.

Wallbox or first housing 12 also includes a center mark in the form of a notch 18. Notch 18 is disposed on a front edge of side 12d and is for allowing this box or first housing to be aligned with a particular position on a stud beam. Notch 18 is designed to allow a user to have visual alignment of the box on a wall stud or beam.

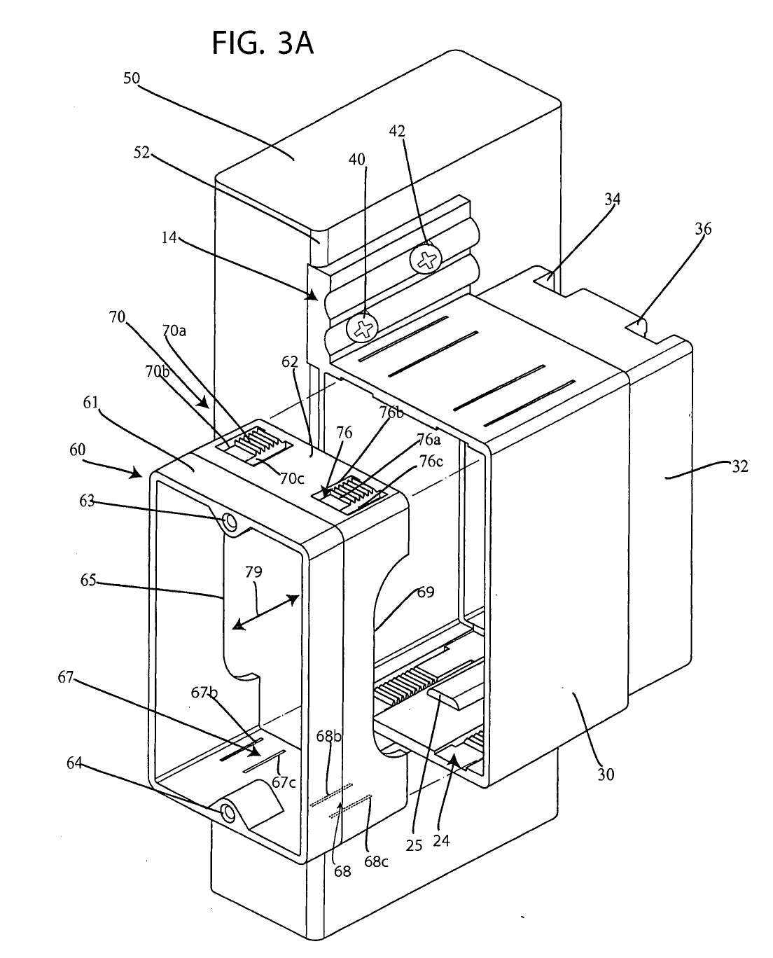

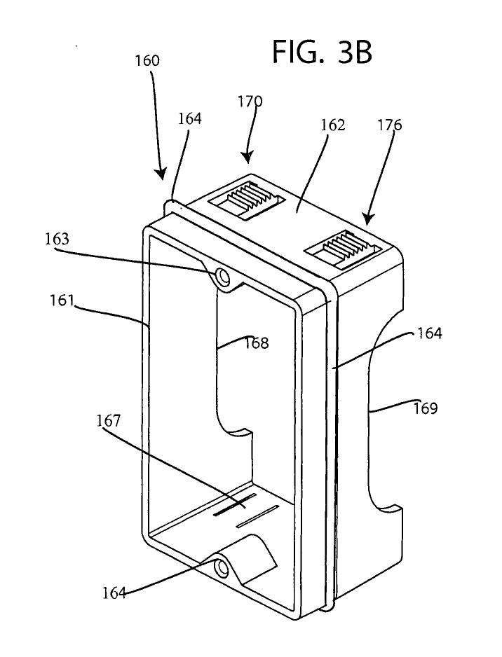

First housing 12 includes connection elements as well. These connection elements include a first connection element 20 a second connection element 24, a third connection element 26, and a fourth connection element 28. Each of these connection elements extends into an inner region of first housing 12 from inside faces of sides 12a and 12c. While there are four connection elements shown, any number of connection elements in this case can be used. These connection elements can be used to connect first housing 12 with insert box or second housing 60 (See FIG. 3A).

First connection element 20 includes a ribbed or ratcheted section 20a and slots 20b and 20c. The other connection elements 24, 26 and 28 are designed similarly. For example, second connection element 24 includes a ratcheted section 24a with slotted sections 24b and 24c disposed on each side of ratcheted section 24a. The slots formed in these connection elements are designed to allow the ribbed sections to bow or bend when a insert box is inserted into box 12.

The ratcheted sections of connection elements 20, 24, 26, and 28 include teeth which are formed on inside faces of this first housing 12. Each of these teeth has a first face which is angled or sloped away from the front face of first housing 12 and faces a front end of first housing 12. These teeth also have a second face which extend substantially perpendicular to these inside faces and face the back face or back edge of first housing 12.

Disposed between these connection elements is a center region. For example, center region 21 is disposed between connection elements 20 and 24 while center region 23 is disposed between connection elements 26 and 28.

There is also a stopper 25 which is disposed in the center region 21 between connection elements 20 and 24. This first housing 12 includes a front section 30 and a back section 32. Back section 32 is formed such that it has a smaller peripheral size than front section 30. Back section 32 also includes strain relief indents, 34 and 36 for receiving cables which can be inserted into a back of box or first housing 12. A plurality of screws or other known fasteners can be used to couple box or base 12 to a stud beam. In this view, screws 40 and 42 are shown inserted into bracket 14, while screws 44, and 46 are shown inserted into bracket 16. Accordingly, bracket 14 can have screw holes for receiving screws while bracket 16 can also have holes for receiving screws. Alternatively, instead of screws other fastening elements such as nails, bolts or other known fasteners can also be used. In addition, first housing 12 also includes at least one locator element. In one embodiment, the locator element is in the form of a ferromagnetic element 57 such as a steel strip. In another embodiment, the locator element is in the form of prongs, pins or tabs are shown as 55a, 55b, 55c, or 55d. Any number of prongs could be used such that one or more prongs could be placed in the corners of first housing 12 to mark first housing 12 once a wallboard is placed up against the first housing 12. In at least one embodiment, the prongs are formed integral with first housing 12. In another embodiment, these prongs can be formed from a material different from first housing 12. These prongs 55a, 55b, 55c, or 55c can be formed so that they extend out a from the front face of housing 12 a sufficient distance so as to puncture a contacting surface of the wallboard so as to make a mark. Alternatively, these prongs, pins or tabs 55a, 55b, 55c, or 55d can be formed so that they extend out from the front face of housing 12 a sufficient distance so as to pierce entirely through the depth of the wallboard thereby leaving a noticeable mark on the surface of the wallboard after it is placed on the wall and fastened to the wall.

With the first design of prongs 55a, 55b, 55c, or 55d, a wallboard having at least one impressionable interface such as paper could be placed against first housing 12 causing an indent or mark in this first housing 12. Then, when the wallboard is removed for cutting, a user would have a mark to read where to cut an opening in the wallboard for removal of a section of the wallboard. In this case, only one mark may be sufficient so that a user could then line up a template of the box on that one mark, and then have an outline of the section to be cut.

With the other design of prongs 55a, 55b, 55c or 55d, the prongs puncture entirely through the wallboard when it is mounted on the wall, Therefore, the user does not have to remove the wallboard to see the inside markings on the wallboard.

In addition, as described above, in one alternative embodiment the box 12 has a ferromagnetic or steel element 57 embedded in box 12. A user putting up a wallboard could then use a magnet to determine the point on the box where the steel element is based. From this detected point, the user could then use a template or another box to form an outline for purposes of cutting a hole in the wallboard to allow electrical components to be inserted therein.

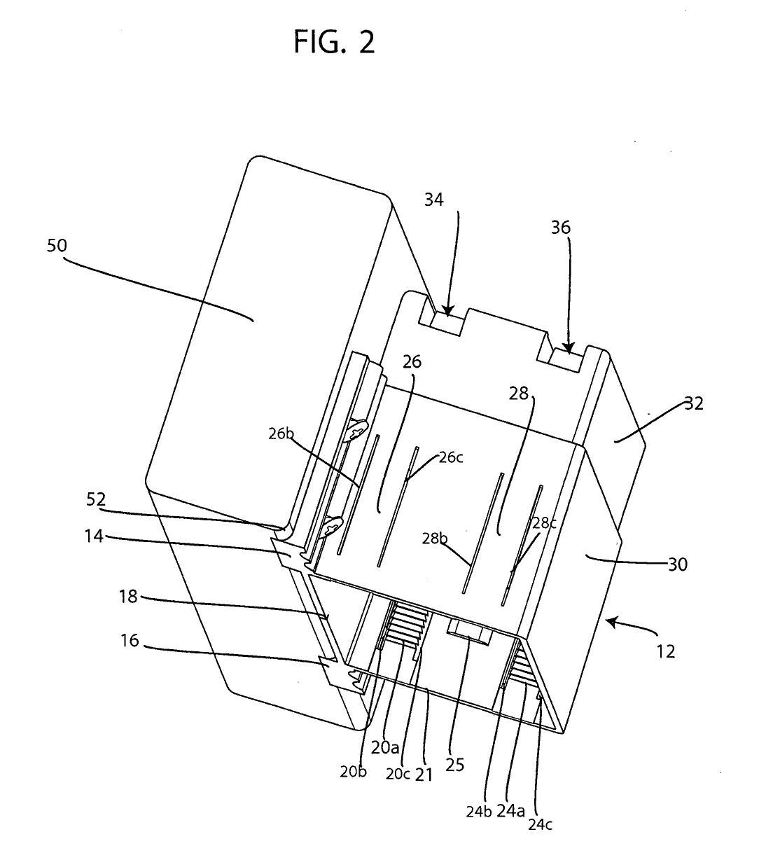

FIG. 2 is a top perspective view of first housing or base box 12. In this view, box 12 is shown coupled to beam or column 50. Column 50 includes a beveled section 52 which has been rounded at its corner. Brackets 14 and 16 include associated lips 15 and 17 which are shown extending across the front section of beam 50 and extending across beveled section 52. In addition, in this view, notch 18 is shown as positioned adjacent to beam or column 50 for lining up first housing 12 with a particular region on beam 50.

FIG. 2 shows connection elements 20, 24 and 26 in greater detail. For example, second connection element 24 includes ribbed section 24a as well as slotted sections 24b and 24c. Third connection element 26 has a ribbed section similar to that of first connection element 20, but which is not shown in this view. Third connection element 26 has slots 26b and 26c. Finally, fourth connection element 28 includes slots 28b and 28c as well as a ribbed section which is similar to the ribbed section in connection element 20 but which is not shown in this view. This view also shows front section 30 of box 12, as well as back section 32. From this view, strain relief indents 34 and 36 can be shown as indented gaps formed in back section 32.

FIG. 3A is a perspective view of first housing 12 and second housing 60. In this view, second housing 60 includes coupling elements such as screw holes 63 and 64 and connection elements 67, 68, 70, and 76. Each connection element has an associated ratcheted section and slotted sections. For example, connection element 67 includes a ratcheted section (not shown) and slotted sections 67b and 67c. Connection element 68 which is shown by a dotted line includes a ratcheted section (not shown) and slotted sections 68b and 68c disposed on both sides of this ratcheted section. In addition, connection element 70 includes a ratcheted section 70a and slotted sections 70b and 70c disposed on each side of ratcheted section 70a. Connection element 76 includes a ratcheted section 76a and slotted sections 76b and 76c disposed on each side of ratcheted section 76a. The ratcheted sections of connection elements 67, 68, 70, and 76 include teeth which are formed on the outside face of this second housing 60. Each of these teeth have a first face which extends away from the outside face of second housing 60 in an angled manner and which substantially faces a back end of second housing 60. These teeth also have a second face which extend substantially perpendicular to these outside faces and face the front face or edge of second housing 60.

Second housing 60 includes a front section 61 and a back section 62. Back section 62 includes C shaped cutouts 65 and 69 which are designed to allow user to easily hold second housing 60 when inserting second housing 60 into first housing 12.

First housing 12 is shown as being attached to beam 50 similar to that as shown in FIG. 2. First bracket 14 is shown as receiving screws 40 and 42 for securing first housing 12 to beam 50. At this point, first housing 12 is ready to receive second housing 60. Accordingly, second housing 60 can be inserted into first housing 12 such that connection element 67 meshes with connection element 20, connection element 68 meshes with connection element 24, connection element 70 meshes with connection element 26, and connection element 76 meshes with connection element 28. This meshing or interaction between the connection elements is such that each ratcheted section meshes or slides over the opposite associated ratcheted section. Once second housing 60 is slid into first housing 12, it is selectively locked in place such that the associated connection sections on second housing 60 and first housing 12 form a lock to keep second housing 60 inside first housing 12. Second housing 60 can be inserted further into first housing 12 until a back edge of second housing 60 contacts stopper 25, however the lock formed by the connection sections would prevent second housing 60 from moving in an opposite direction or being removed from first housing 12. At this point, second housing 60 would reside in a front section 30 of first housing 12, while back section 32 is designed to receive a set of wires into openings formed as cable strain reliefs 34 and 36.

The depth adjustment in this embodiment is possible because the faces of the teeth that slide over each other can be formed in a sloped manner to allow these teeth to slide over each other, while the opposite faces of these teeth can be formed as flat edges for locking. In addition because these teeth mesh together as described above, these teeth create a self locking connection element which locks the second housing into the first housing without requiring any additional tools.

Second housing 60 can be inserted into first housing 12 in a direction shown by arrow 79 which is in a direction substantially perpendicular to a plane formed by a wallboard connected to post or column 50. As the second housing is being inserted into the first housing, each time the teeth on each ratchet move over each other, it incrementally locks the second housing into the first housing. In at least one embodiment, this selective locking of the connection element or connection elements keeps the second housing locked into the first housing and prevents it from sliding back out of the first housing.

As the second housing is pushed further into the first housing, each movement of the teeth over each other on the corresponding connection elements causes an increasing amount of the depth of the second housing to be locked into the first housing. With this locking connection of this embodiment, the second housing can only be pushed further into the first housing without being pulled out.

An electrical component such as a standard off the shelf receptacle unit or a standard off the shelf switch unit can be connected to the second housing before installing the second housing into the first housing. A standard off the shelf electrical component can also have a strap which extends outside of the body of this second housing. Once the electrical component is coupled to the second housing, this strap can then be used to contact a wallboard on a wall, such that this strap can serve as a stopper, stopping the insertion of the second housing as it is being inserted into the first housing.

In addition, a face plate can be connected to the electrical component before installation of the second housing into the first housing. Once this face plate has been connected, the outer edges of this face plate can be used to contact the wall board as well to stop any further insertion of the second housing into the first housing.

In addition, in at least one embodiment, another stopping element can be in the form of a stopper disposed inside of the first housing, wherein this stopper is in the form of a face which contacts an inner edge of the second housing as it is being inserted into the first housing.

While there can be any suitable number of connection elements for connecting the second housing to the first housing, in at least one embodiment, the second housing can have four connection elements, and the first housing can have at least four corresponding connection elements.

FIG. 3B is a perspective view of another embodiment of the invention. For example, in this view there is shown second housing 160 having a mud ring 164 disposed around a front section 161. Front section 161 also includes screw holes 163 and 164. In addition, a back section 162 which can be formed separate or continuous with front section 161. Back section 162 includes C shaped indents 168 and 169 as well as a first connection element 167. A second connection element is positioned opposite first connection element 167 but is not shown. Third and fourth connection elements 170 and 176 are similar to connection elements 70 and 76 shown in FIG. 3A and are disposed on a top section of back section 162.

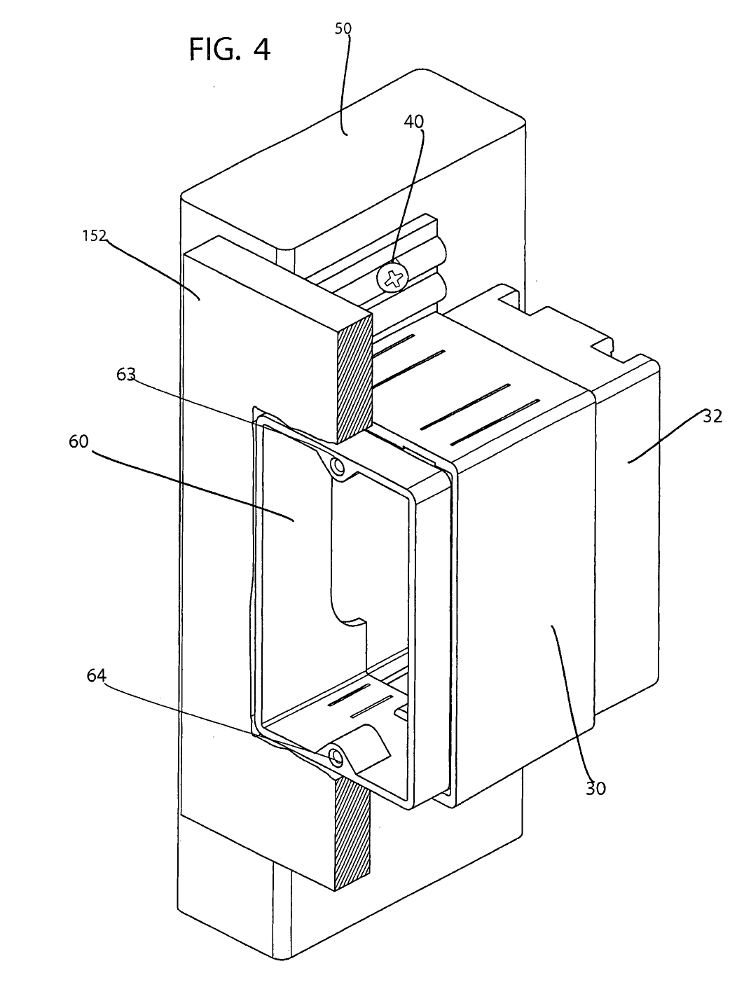

FIG. 4 is a perspective which shows second housing 60 inserting into first housing 12. For example, in this position, first and second connection elements 67 and 68 on second housing 60 are connected with associated first and second connection elements 20 and 24 on first housing 12 (See FIG. 3A). In addition, third and fourth connection elements 70 and 76 are inserted into and connected with associated third and fourth connection elements 26 and 28 of first housing 12.

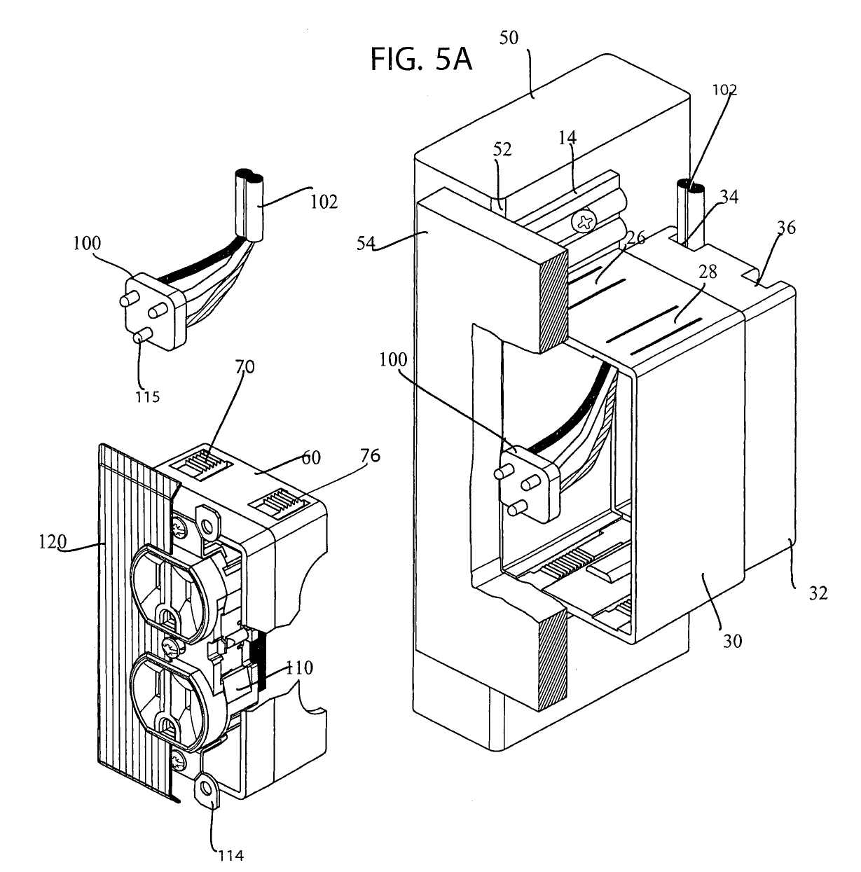

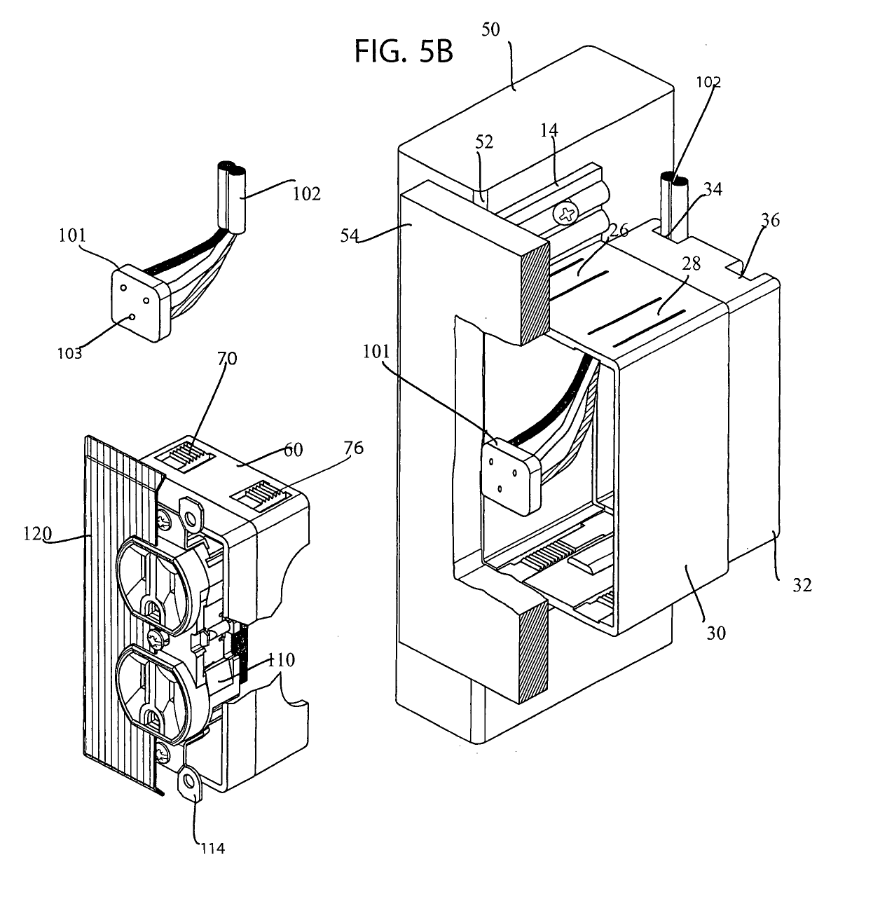

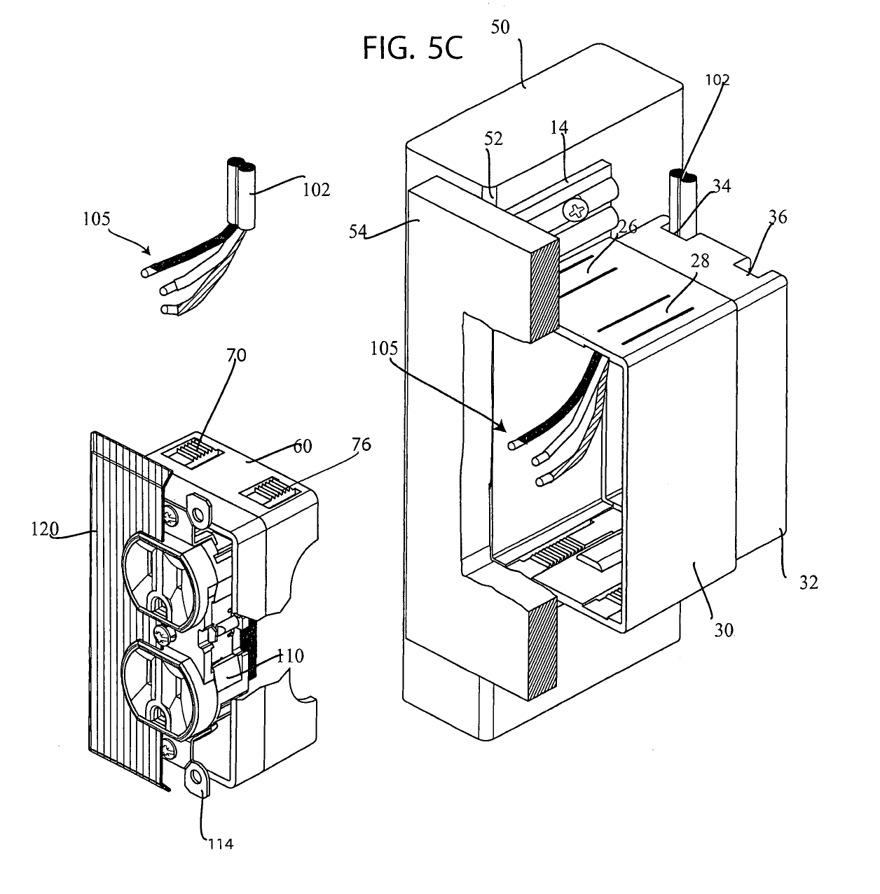

With this type of connection, second housing 60 can be selectively connected to first housing 12 such that the connection elements of second housing 60 can be slid into first housing 12 in a telescoping manner. When the associated connection sections 67, 68, 70, and 76 contact the associated connection sections 20, 24, 26, and 28 on first housing 12 there is a connection interface formed such that these connection sections form a ratcheted tight connection. In this case, second housing 60 can be slowly pressed into first housing 12 in an incremental manner such that these connection sections slide or snap over each other, resulting in a series of audible clicks as second housing 60 is inserted. Once the depth of insertion of second housing 60 has been determined, second housing 60 can remain locked in that position with the front face of second housing 60 set as flush with wallboard 54. Thus, wallboards of different depths can be attached to a beam or post 50, while the depth of second housing 60 can be adjusted to meet these different depths of wall boards 54. This way, an associated receptacle unit, such as unit 110 shown in FIGS. 5A, 5B and 5C, can have its face extending either flush with, or slightly extended in front of wallboard 54.

In this embodiment, the second housing 60 can have a substantially rectangular cross section having four corners. The four connection elements 67, 68, 70 and 76 on the second housing 60 (See FIG. 3A) can be positioned adjacent to the four corners of the second housing 60. In addition, the corresponding first housing 12 can also be shaped substantially rectangular as well, wherein these four connection elements 20, 24, 26 and 28 are correspondingly positioned adjacent to the four corners of the first housing as well (See FIG. 1).

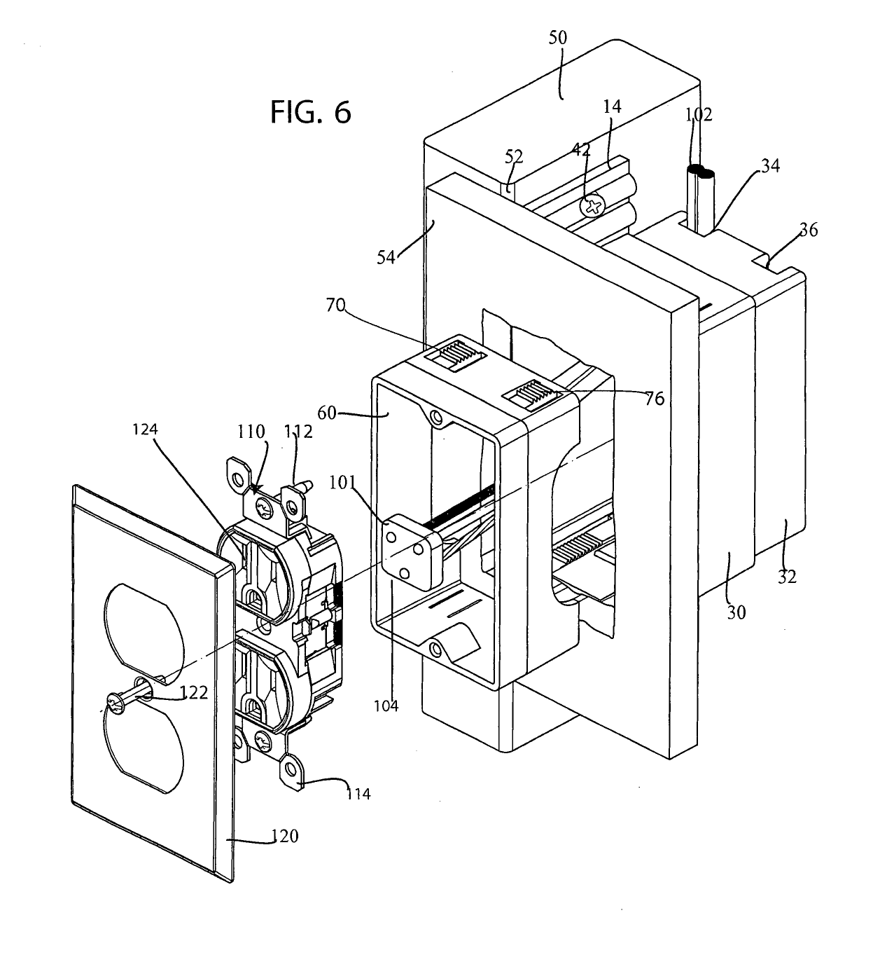

FIG. 5A is a perspective view of the embodiment of the device shown in FIGS. 13A. In this view, second housing 60 has an associated receptacle unit 110 connected to this unit via screws 112 (See FIG. 6) Receptacle unit 110, which is connected to second housing 60, forms a single modular unit which can then be connected to first housing 12. In addition, there is a modular electrical connection element which can be referred to as a pig tail 100 which is connected to wires 102 wherein these wires 102 feed electrical power to prongs 104 on connection element 100.

When modular connection element 100 is connected to receptacle unit 110 then there is power to these terminals 124 (See FIG. 6). Modular connection element 100 can be formed in any known manner, for example FIGS. 5A, 5B and 5C show three different types of connection systems.

For example FIG. 5B shows another modular electrical connection element or pig tail 101 which has female connection elements 103 for receiving male connection elements (not shown) on a receptacle 110. FIG. 5C shows another connection element wherein free stripped ends of wires 105 are used to connect to a receptacle in any known manner. One type of modular connection that can be used is shown in U.S. patent application Ser. No. 11/553,793 filed on Oct. 27, 2006, and titled “Modular Wiring System with Locking Elements”, the disclosure of which is hereby incorporated herein by reference in its entirety.

Once receptacle unit 110 is connected to modular connection element 100, second housing 60 can be inserted into first housing 12 in the manner described above. For example, as second housing 60 is inserted into first housing 12, the associated connection elements on second housing 60 mesh with associated respective connection elements 20, 24, 26 and 28 on first housing 12 to form a ratchet type connection that is incrementally adjustable in terms of depth. Receptacle unit 110 can have a strap 114 extending outside of second housing 60 which acts as a stopper, stopping the incremental insertion of second housing 60 into first housing 12 when strap 114 contacts wallboard 54. In addition, a front faceplate 120 connected to second housing 60 can be used as a stopper wherein the user can simply slide second housing 60 into first housing 12 with these connection elements incrementally ratcheting in, until faceplate 120 contacts wallboard 54. In this way, front faceplate 120 controls the depth of insertion of second housing 60 when it contacts wallboard 54. Thus, a user would have the appropriate depth for receptacle unit 110 each time that user connected second housings 60 with first housing 12.

If a user decided to disassemble or remove receptacle unit 110 from second housing 60, that user can simply unscrew screw 122 from receptacle unit 110 to remove faceplate 120. Next, that user could unscrew screw screws 112 to remove receptacle unit 110 from connection or second housing 60. As that user pulls receptacle unit 110 away from second housing 60, modular connection element 100 becomes exposed. At this point, if the user starts to pull too far on receptacle unit 110, cable strain relief 34 keeps wires 102 from pulling too far out of a wall. With modular connection element 100 exposed, the user can then disconnect modular connection clement 100 from receptacle unit 110.

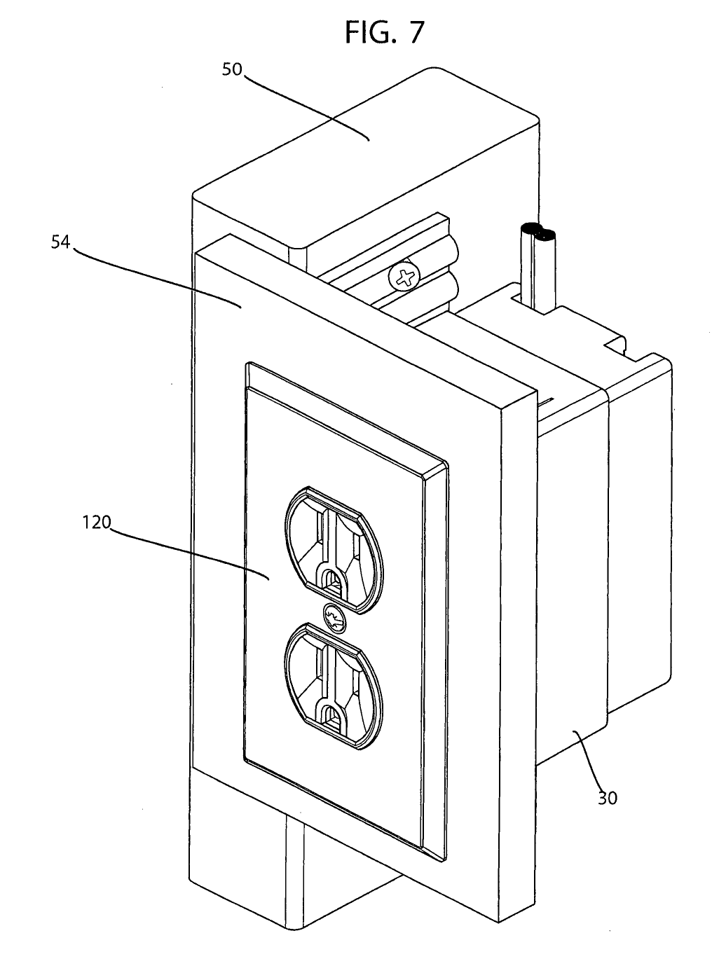

Alternatively, a user could decide to leave the device in an assembled condition as shown in FIG. 7. In this view, faceplate 120 is shown pressed against wallboard 54 to form a flush connection. With second housing 60 inserted into first housing 12, receptacle unit 110 is positioned in the stable manner inside of first housing 12 at the proper depth in relation to wallboard 54. Thus, with this design, users with little experience with electrical wiring can achieve a proper electrical connection of a receptacle unit 110 to wires 102 as well as the proper physical connection of a receptacle unit 110 to a first housing or wall box 12.

With the design as described above, the installation of electrical components into a wall box is greatly simplified while the quality of the installation is maintained.

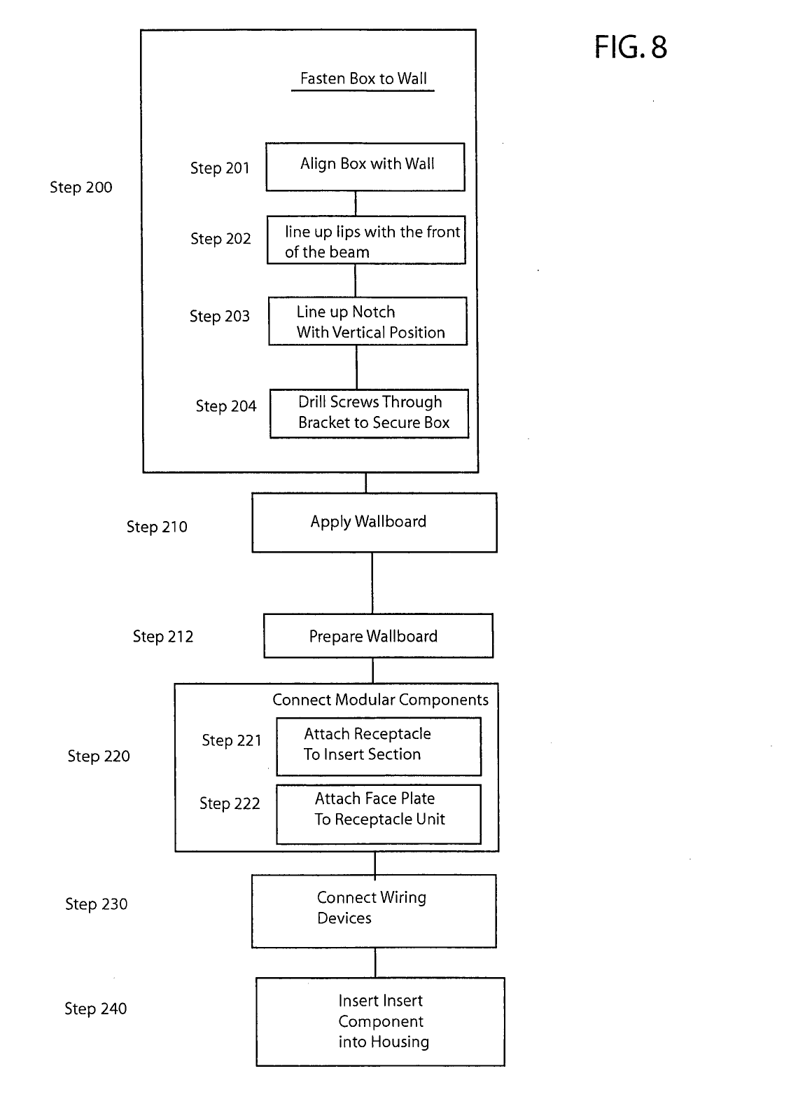

For example, with this design, electrical components can be installed in a new manner. FIG. 8 discloses a series of steps for installing an electrical device into a wall unit. Step 200 includes fastening a first housing or box such as first housing 12 to a stud or beam on a wall. Step 200 can include a series of sub steps, for example, in step 201, a user can align a box with a wall beam. This step can involve lining up lips 15 and 17 with a front end of beam 50 in step 202. Next, in step 203 a user can line up notch 18 with a vertical position on beam 50 to set the height or vertical position of wall box or first housing 12. Next, in step 204, the user can drill self aligning screws such as screws 40, 42, 44, or 46 into brackets 14 and 16 to fasten box 12 to column 50. In step 210, a user can then apply a wallboard such as wall board 54. An optional step in this series is step 212 which includes identifying and preparing the wallboard for mounting with an opening to accommodate the first housing 12. At this point, the user can determine the size, shape and positioning of the hole or opening in the wallboard that is necessary to access the first housing. To aid in this step, optional prongs 55a, 55b, 55c, or 55d can be used to make an imprint in a wallboard such that it allows a user to have an outline for cutting.

Once at least one point on the wallboard is identified, then the user can apply another first housing or a template to the wallboard so as to create a pre defined cutting area for cutting an opening in the wallboard. Alternatively, or in addition, first housing 12 can include ferromagnetic or steel elements 57 which can be embedded in first housing 12. Once a wallboard is mounted on a wall, first housing 12 can be identified via at least one magnet being applied to the wallboard to identify the placement of the ferromagnetic or steel element 57. At this point, once this element is identified, then a user can cut the appropriate opening in the wallboard.

In step 220, a user can connect the modular components which can include second housing 60, receptacle unit 110 and face plate 120. This connection can occur in a factory or on site. Accordingly, if this connection between second housing 60 and receptacle unit 110 occurs in the factory, then it can occur before step 200. For example, step 221 includes attaching a receptacle unit 110 to second housing 60. This can occur by screwing in screws 112 into second housing 60. Next, a user can attach face plate 120 to receptacle unit 110 by screw 122. In step 230 a user can connect the modular connection element or terminal 100, 101 or 105 to a back end of terminals in receptacle unit 100. Finally, in step 240, a user can insert, the second housing 60 which has receptacle unit 110 and face plate 120 attached to it into first housing 12. As stated above, second housing 60 is inserted into first housing 12 in a telescoping manner with the associated connection elements 20, 24, 26, and 28 lining up with connection elements 67, 68, 70 and 76. The insertion of this second housing 60 slides inside of front section 30 of first housing 12 so that its sides are enclosed by this front section 30. The incremental insertion of second housing 60 is achieved by the ratchet sections of these connection sections meshing with each other. As this second housing 60 is inserted therein, it is locked in place so that it cannot be removed forming a secure connection that can be fixed in all directions. Because of the design of the teeth, as the second housing 60 is inserted into first housing 12, the sloped or angled faces of these teeth slide over each other. If a user tried to pull second housing 60 out of first housing 12, then the flat back, or opposite faces on these teeth would contact each other locking second housing 60 into first housing 12. Thus, this design results in a self locking second housing as it is inserted into first housing 12, allowing a user to insert this second housing 60 into first housing 12 without needing any additional tools.

This design therefore affords an easy installation and ensures a high quality connection so that relatively unskilled tradesman can be used for the installation of these components.

In at least one embodiment, a user can insert at least one tool such as a screwdriver to disconnect the second housing 60 from the first housing 30. This can be achieved by sliding the screwdriver or other type of pronged instrument into a slot formed between the connection of the two devices. In that way, the screwdriver or pronged instrument interrupts the connection between the connection elements and then allows the second housing 60 to be slid out from first housing 30.

Alternatively, a screwdriver or pronged instrument can be inserted into any one of the associated slots 20b, 20c, 24b, 24c, 26b, 26c, 28b, or 28c from the outside to pry these connection elements apart. Or the user can insert a tool such as a screwdriver into slots 67b, 67c, 68b, 68c, 70b, 70c, 76b, or 76c from the inside to disconnect the connection between the connection elements on the first housing and the second housing from the inside to pry these connection elements apart thereby enabling second housing 60 to be pulled from first housing 12.

These different embodiments can be presented to an end user for sale in a plurality of different ways. For example, the electrical device can be coupled to the second housing in a factory first, and then this combination device can be sold to an end user. Alternatively, the first housing and the second housing can be sold together in the form of a kit, with or without an electrical device. If the kit included an electrical device, in one embodiment, this kit would include the electrical device coupled to the second housing. In another embodiment, this kit would include all of the components in a separate state, wherein these components can then be coupled together at a particular site. Alternatively, each of these components can be sold separately, and then combined later at a particular site. This kit can also optionally include a faceplate as well.

Accordingly, while a few embodiments of the present invention have been shown and described, it is to be understood that many changes and modifications may be made thereunto without departing from the spirit and scope of the invention as defined in the appended claims.

What is claimed is:

1. An electrical component connection device comprising:
a) a first housing comprising a wall box;
b) a second housing adjustably and releasably connected to said first housing in at least one of a plurality of depths within said first housing, said second housing sized to receive at least one electrical component; and
c) at least one connection element coupled to said first housing which connects said first housing with said second housing, said at least one connection element having at least one slot formed in said housing and extending through said first housing.

2. The device as in claim 1, wherein said at least one slot comprises at least two slots disposed on each side of said at least one connection element.

3. The device as in claim 1, wherein said second housing comprises at least one connection element having at least one slot, which is adapted to connect to said first housing.

4. The device as in claim 3, wherein said at least one slot on said first connection element comprises at least two slots spaced parallel from each other, and said at least one slot on said second connection element comprise at least two slots spaced parallel from each other.

5. The device as in claim 1, wherein said first housing further comprises at least one mounting bracket for mounting said first housing to a surface, and wherein said at least one mounting bracket comprises a lip extending substantially perpendicular to said mounting bracket.

6. The device as in claim 1, wherein said at least one connection element on said first housing comprises a ratchet section.

7. The device as in claim 1, wherein said first housing comprises at least four connection elements and said second housing comprises at least four connection elements and wherein each connection element comprises a ratcheted section and at least two slots disposed adjacent to said ratcheted section to make said ratcheted section selectively movable such that when said connection elements on said second housing mesh with said connection elements on said first housing, said ratcheted sections slide over each other to maintain said second housing in said first housing.

8. The device as in claim 7, wherein said first housing further comprises a stopper in the form of a contact surface for stopping the insertion of said second housing into said first housing.

9. The device as in claim 1, wherein said first housing further comprises at least one notch disposed along an edge of at least one side of said first housing, said notch being positioned in a substantially center region of a length of a front edge of said first housing.

10. The device as in claim 1, wherein said first housing further comprises at least one strain relief section for receiving at least one wire into said housing.

11. The device as in claim 1, further comprising at least one locator element coupled to said first housing, such that when a wallboard is placed in front of said first housing, said locator element is for allowing a user to locate a position of said first housing on said wallboard.

12. The device as in claim 12, wherein said locator element comprises at least one prong coupled to said first housing, wherein said at least one prong is adapted such that when a wallboard is pressed against said first housing, said at least one prong presses into said wallboard to create an impression in said wallboard.

13. The device as in claim 1, wherein said at least one prong is disposed in a corner region of said first housing extending out from a front face of said first housing.

14. The device as in claim 13, wherein said locator element is in the form of a ferromagnetic element.

15. The device as in claim 1, further comprising a mud ring.

16. The device as in claim 1, wherein said second housing further comprises C shaped cut outs.

17. The device as in claim 8, wherein said first housing has a first section and a second section, said first section for receiving said second housing, wherein said stopper extends from said second section of said housing along a side of said first section of said first housing.

18. The device as in claim 12, wherein said prong is coupled to a peripheral edge on a front face of said first housing.

19. The device as in claim 15, wherein said mud ring is coupled to said second housing.

20. A wallbox comprising:
a) a housing; and
b) at least one locator element coupled to said housing.

21. The wallbox as in claim 20, wherein said at least one locator element is in the form of a prong.

22. The wallbox as in claim 21, wherein said prong is formed such that it extends a length sufficient to pierce through an entire depth of said wallboard when said wallboard is placed flush against said front face of said housing.

23. The wallbox as in claim 20, wherein said at least one locator element is in the form of a ferromagnetic element coupled to said housing.

24. The wallbox as in claim 23, wherein said ferromagnetic element is in the form of a strip of ferromagnetic metal coupled to said housing.

25. A wallbox for an electrical component comprising:
a) a housing having a front face;
b) a notch disposed in said housing;
c) at least one prong coupled to said housing; and
d) at least one lip coupled to said housing, wherein said notch is for assisting a user in placing said housing at a particular height on a wall, said at least one prong is for rendering at least one imprint on a wallboard when the wallboard is placed against said housing, and said lip is for attaching said front face of said housing substantially parallel to a front face of a support column.

26. A method for installing an electrical device to an electrical box comprising:
a) mounting an electrical box to a mounting surface, said electrical box capable of receiving a depth adjustable housing;
b) inserting a depth adjustable housing into said electrical box;
c) slidably adjusting the depth in which said depth adjustable housing is inserted into said electrical box; and
d) coupling an electrical device to said depth adjustable housing.

27. The method for installing the electrical component as claimed in claim 26, wherein said step of mounting said electrical box to a mounting surface comprises lining up a notch on said electrical box with a position on said column to set a proper height for said electrical box on said column.

28. The method as in claim 26, wherein said step of mounting said electrical box to a mounting surface includes lining up at least one lip on said electrical box with said column to set a proper depth of said electrical box on said column.

29. The method as in claim 26, wherein said step of electrically connecting said electrical device to a source of power comprises coupling a modular electrical connection element to said electrical component.

30. The method as in claim 29, wherein said step of coupling said depth adjustable housing to said electrical box comprises coupling at least one coupling element on said depth adjustable housing to at least one coupling element on said wall box.

31. The method as in claim 26, wherein said step of locating said electrical box relative to said wall board includes placing a wallboard substantially flush against a front surface of said electrical box such that at least one prong on said electrical box pierces through at least one surface on the wallboard.

32. The method as in claim 26, wherein said step of locating said electrical box relative to said wall board includes placing a magnet against said wallboard to locate a ferromagnetic material coupled to said electrical box.

33. The method as in claim 26, wherein said step of coupling said electrical device to said depth adjustable housing comprises coupling said electrical device to said depth adjustable housing before said depth adjustable housing is inserted into said electrical box.

34. The method as in claim 26, wherein said step of coupling said electrical device to said depth adjustable housing comprises coupling said electrical device to said depth adjustable housing after said depth adjustable housing is inserted into said electrical box.

35. A method for installing an electrical device into a wall box comprising:
a) setting a position of the wall box relative to a mounting surface;
b) mounting said wall box to a mounting surface, said wall box capable of receiving a depth adjustable housing;
c) inserting an electrical device connected to said depth adjustable housing into said walll box; and
d) slidably adjusting the depth in which said depth adjustable housing is inserted into said electrical box.

36. The method as in claim 35, wherein said step of setting a position of said wall box comprises lining up at least one lip on said wall box with a column of a wall to set a proper depth of said wall box on said column.

37. The method as in claim 35, wherein said step of setting a position of said wall box comprises lining up at least one notch on said wall box with a position on said column to set a proper height for said electrical box on said column.

38. An electrical device comprising:
a) an electrical body;
b) a housing coupled to said electrical body, wherein said housing substantially surrounds at least one peripheral surface of said electrical body, and wherein said housing comprises at least one connection element which is connectable to a wallbox and wherein said housing is sized to fit within said wallbox.

39. The electrical device as in claim 38, wherein said housing further comprises a mud ring.

40. The electrical device as in claim 38, wherein said housing further comprises C-shaped cut outs.

41. The electrical device as in claim 38, wherein said at least one connection element comprises at least one slot.

42. A method for selling electrical devices comprising:
a) coupling at least one electrical device to a housing wherein said housing has at least one connection element for coupling to a wallbox; and
b) presenting said at least one electrical device coupled to said housing for sale.

43. The method for selling electrical devices as in claim 42, wherein said housing coupled to said at least one electrical device is slidable into a wallbox.

44. The method for selling electrical devices as in claim 42, wherein said step of coupling at least one electrical device to a housing includes coupling said at least one electrical device to a housing having at least one connection element which is connectable to a wallbox.
